(19) United States
(12) Patent Application Publication
(10) Pub. No.: US 2019/0149583 A1
(43) Pub. Date: May 16, 2019

(54) Initial IMS Registration

(71) Applicant: MEDIATEK Singapore Pte. Ltd, Singapore (SG)

(72) Inventors: Sami Jutila, Oulu (FI); Rohit Naik, Hsinchu (TW); Marko Niemi, Oulu (FI); Wei-Chiang Peng, Hsinchu (TW); Chien-Chun Huang-Fu, Hsinchu (TW)

(21) Appl. No.: 16/188,584

(22) Filed: Nov. 13, 2018

Related U.S. Application Data
(60) Provisional application No. 62/584,998, filed on Nov. 13, 2017.

(51) Int. Cl. H04L 29/06; H04W 76/18; H04W 60/00

(52) U.S. Cl. CPC H04L 65/1073; H04L 65/1016; H04L 65/1063; H04W 60/00; H04L 65/1069; H04W 76/18; H04L 65/1006

(57) ABSTRACT

A method of improving initial IMS registration after 403 Forbidden response is proposed. A UE sends a SIP register to an IMS server for initiating IMS registration. The initial IMS registration fails and the UE receives a SIP message with a 403 Forbidden response code. In the 403 Forbidden response code, the IMS server includes an XML body and uses the <reason> header value of the XML body to indicate an error type (e.g., temporary or permanent) followed by a retry-after timer value. As a result, the network can indicate to UE whether the IMS registration rejection is permanent or is due to some temporary internal failure. By adding the retry-after timer value, the network can indicate to UE when to retry the next IMS registration.

### CROSS REFERENCE TO RELATED APPLICATIONS

This application claims priority under 35 U.S.C. § 119 from U.S. Provisional Application No. 62/584,998, entitled “Initial IMS registration after 403”, filed on Nov. 13, 2017, the subject matter of which is incorporated herein by reference.

### TECHNICAL FIELD

The disclosed embodiments relate generally to wireless communication, and, more particularly, to method of improving IMS registration.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G. Voice service will be an important feature for the new generation system, e.g., NG system (NGS) or 5G system (5GS). It is proposed that the NG/5G systems shall support IMS PS voice service, IMS PS voice service continuity with the 4G evolved packet system (EPS), and IMS PS voice service fallback to EPS.

As set forth in the 3GPP, IP Multimedia Subsystem (IMS) is a core network that provides IP multimedia services to user equipments (UEs) over an Internet Protocol (IP) network. Historically, mobile phones have provided voice call services over a circuit-switched (CS) network, rather than strictly over an IP packet-switched (PS) network. Alternative methods of delivering voice or other multimedia services over IP have become available on smartphones (e.g. VoIP or Skype), but they have not become standardized across the industry. IMS is an architectural framework to provide such standardization. IMS is able to communicate with UEs through different types of access network, such as a wireless local area network (WLAN), an Ethernet network, a packet data network (PDN), or another type of access network. IMS is a new way to dial PS call over LTE or over New Radio (NR) (Voice over IP or Voice over LTE or Voice over NR) instead of fallback to 2G/3G legacy CS call.

IMS contains several application services such as voice call (VoLTE or VoNR), SMS, instant message (IM), discovery presence (DP), etc. over the IP network. UE will send SIP REGISTER to the IMS server to inform UE's capability and request for service. The initial IMS registration from the UE may fail due to subscription specific reason or due to some temporary failures in the network. As a result, the network sends a response code 403. TS 24.229 specifies that the UE may or may not initiate second registration attempt after 403. The related RFC specifies that the UE should not re-attempt registration after 403. In TS 24.229, it is specified that if Retry-After value is included in the response, then the initial registration may happen after time indicated in Retry-After has expired. On the other hand, if Retry-After is not included in the response, then the UE behavior is unspecified. However, Retry-After header should not be included with response code 403.

All this means in practice is that the UE behavior after the response code 403 remains unclear, unpredictable and non-uniform, and thereafter complicates the UE inter-operability in different networks. Note that the IMS registration failure reason and the downtime is only known to the network—that is why the network is sending 403 Forbidden response code to begin with. However, such failure reason and downtime are not known to the UE—as the timer value is not shared with UE under the existing art. Therefore, any random retry timer value in UE to send reattempt register is more like a guess and not based on any suggestive value or tangible feedback from the network after 403 response.

A solution is sought.

### SUMMARY

A method of improving initial IMS registration after 403 Forbidden response is proposed. A UE sends a SIP register to an IMS server for initiating IMS registration. The initial IMS registration fails and the UE receives a SIP message with a 403 Forbidden response code. In the 403 Forbidden response code, the IMS server includes an XML body and uses the <reason> header value of the XML body to indicate an error type (e.g., temporary or permanent) followed by a retry-after timer value. As a result, the network can indicate to UE whether the IMS registration rejection is permanent or is due to some temporary internal failure. By adding the retry-after timer value, the network can indicate to UE when to retry the next IMS registration.

In one embodiment, a UE transmits a service request to an application server to initiate a service request in a mobile communication network. The UE receives an error message from the application server indicating that the service request is rejected. The UE obtains retry information on whether the UE can re-transmit a subsequent service request to the application server after receiving the error message. The retry information comprises a time value. The UE re-transmits the subsequent service request when a condition for retransmission is satisfied. Otherwise the UE refrains from retransmission of the subsequent service request when the condition is unsatisfied.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary LTE/5G network supporting improvement for initial IMS registration in accordance with one novel aspect.

FIG. 2 illustrates simplified block diagrams of a user equipment (UE) in accordance with embodiments of the current invention.

FIG. 3 illustrates a first embodiment of IMS registration after 403 without using new timer in accordance with one novel aspect.

FIG. 4 illustrates a second embodiment of IMS registration after 403 without using new timer in accordance with one novel aspect.

FIG. 5 illustrates a first embodiment of IMS registration after 403 using a new timer in accordance with one novel aspect.

FIG. 6 illustrates a second embodiment of IMS registration after 403 using a new timer in accordance with one novel aspect.

FIG. 7 illustrates one embodiment of IMS registration after 403 with reason header to carry error type indication followed by retry after timer value in accordance with one novel aspect.

FIG. 8 is a flow chart of a method of supporting IMS registration after response code 403 in accordance with one novel aspect.

### DETAILED DESCRIPTION

Reference will now be made in detail to some embodiments of the invention, examples of which are illustrated in the accompanying drawings.

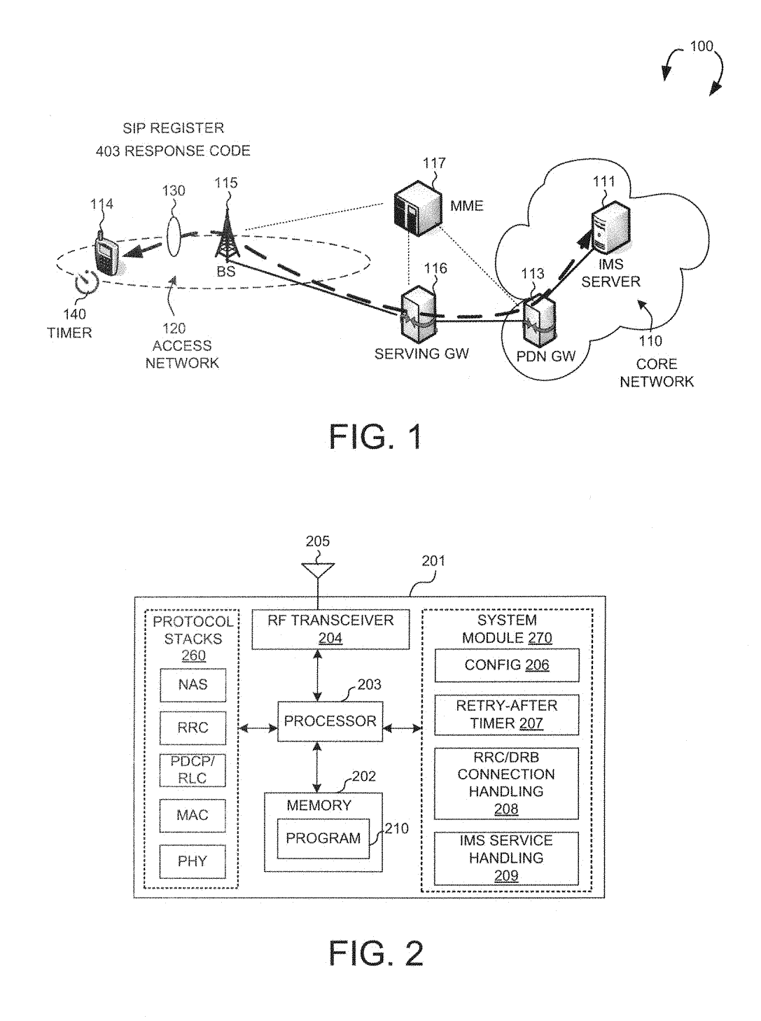

FIG. 1 illustrates an exemplary LTE 4G or new radio (NR) 5G network 100 supporting improvement for initial IP Multimedia Subsystem (IMS) registration in accordance with one novel aspect. LTE/NR network 100 comprises application servers including IMS server 111 that provides various services by communicating with a plurality of user equipments (UEs) including UE 114. In FIG. 1, IMS server 111 and a packet data network gateway (PDN GW or P-GW) 113 belong to part of a core network CN 110. UE 114 and its serving base station BS 115 belong to part of a radio access network RAN 120. RAN 120 provides radio access for UE 114 via a radio access technology (RAT). IMS server 111 communicates with UE 114 through PDN GW 113, serving GW 116, and BS 115. A mobility management entity (MME) 117 communicates with BS 115, serving GW 116 and PDN GW 113 for mobility management of wireless access devices in LTE network 100. UE 114 may be equipped with a radio frequency (RF) transceiver or multiple RF transceivers for services via different RATs/CNs. UE 114 may be a smart phone, a wearable device, an Internet of Things (IoT) device, a tablet, etc.

LTE and NR networks are packet-switched (PS) Internet Protocol (IP) networks. This means that the networks deliver all data traffic in IP packets, and provide users with Always-On IP Connectivity. When UE joins an LTE/NR network, a Packet Data Network (PDN) address (i.e., the one that can be used on the PDN) is assigned to the UE for its connection to the PDN. LTE/NR calls the UE's “IP access connection” an evolved packet system (EPS) bearer, which is a connection between the UE and the P-GW. The P-GW is the default gateway for the UE's IP access. LTE/NR has defined a Default EPS Bearer to provide the IP Connectivity that is Always-On. UE may establish additional data radio bearers for data communication.

IMS is a core network that provides IP multimedia services to UEs over an IP network. IMS contains several application services such as voice call (VoLTE or VoNR), SMS, instant message (IM), discovery presence (DP), etc. over the IP network. UE will send a Session initiation protocol (SIP) REGISTER to the IMS server to inform UE's capability and to request for IMS service. The initial IMS registration from the UE may fail due to subscription specific reason or due to some temporary failures in the network. As a result, the network sends a response code 403. However, the UE behavior after the response code 403 remains unclear, unpredictable and non-uniform under the existing art, and thereafter complicates the UE inter-operability in different networks. Further, since the reason for 403 could be due to temporary internal failure in the network and the time to recover from such failure is known only to network and not to UE. Therefore, any random retry timer value in UE to send reattempt register is more like a guess and not based on any suggestive value from the network after 403 response.

In accordance with one novel aspect, it is proposed that in the 403 Forbidden response code, the IMS server include an XML body and uses the <reason> header value of the XML body to indicate the error type (e.g., temporary or permanent) followed by a retry-after timer value. As a result, the network can indicate to UE whether the IMS registration rejection is permanent or is due to some temporary internal failure. By adding the retry-after timer value, the network can indicate to UE when to retry the next IMS registration. Note that the IMS registration failure reason and the downtime is known to the network—that is why the network is sending 403 Forbidden response code to begin with. However, such failure reason and downtime are not known to the UE—as the retry-after timer value is not shared with UE under the existing art. Therefore, by introducing the <reason> header value of the XML body in 403 Forbidden response code, UE is able to obtains tangible feedback and guidance from the network for the reattempt of IMS registration. The network aided retry-after timer can help the UE to retry the next IMS registration effectively.

In the example of FIG. 1, UE 114 first sends a SIP REGISTER message to IMS server 111 to initiate an IMS registration. When IMS server 111 rejects the SIP request and identifies a failure reason, it sends a SIP message with 403 Forbidden response code to UE 114. The 403 Forbidden response code contains an error type followed by a retry-after timer value. Accordingly, UE 114 knows whether the type of rejection is permanent or temporary and when to reattempt the IMS registration. In one embodiment, if the Retry-After header is included in 403 response, then UE can retry the IMS registration after the retry-after time is elapsed. In another embodiment, UE can start a new timer upon receiving 403 response to control the reattempt of the initial IMS registration. The new timer can be separately configured or through the Retry-After header in 403 response.

FIG. 2 illustrates simplified block diagrams of a UE 201 in accordance with embodiments of the current invention. UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of protocol stacks 260 and control circuits including various system modules and circuits 270 to carry out functional tasks of UE 201. Protocol stacks 260 comprises Non-Access-Stratum (NAS) layer to communicate with a mobility management entity (MME) connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network. In one example, system modules and circuits 270 comprise a configuration circuit 206 that obtains configuration information for IMS retry including a retry-after timer value, a retry-after timer 207 that is started upon receiving the 403 Forbidden response code, a connection handling circuit that handles RRC connection for control and establishes DRB connection for data, and an IMS service handling circuit 209 for performing IMS functionalities.

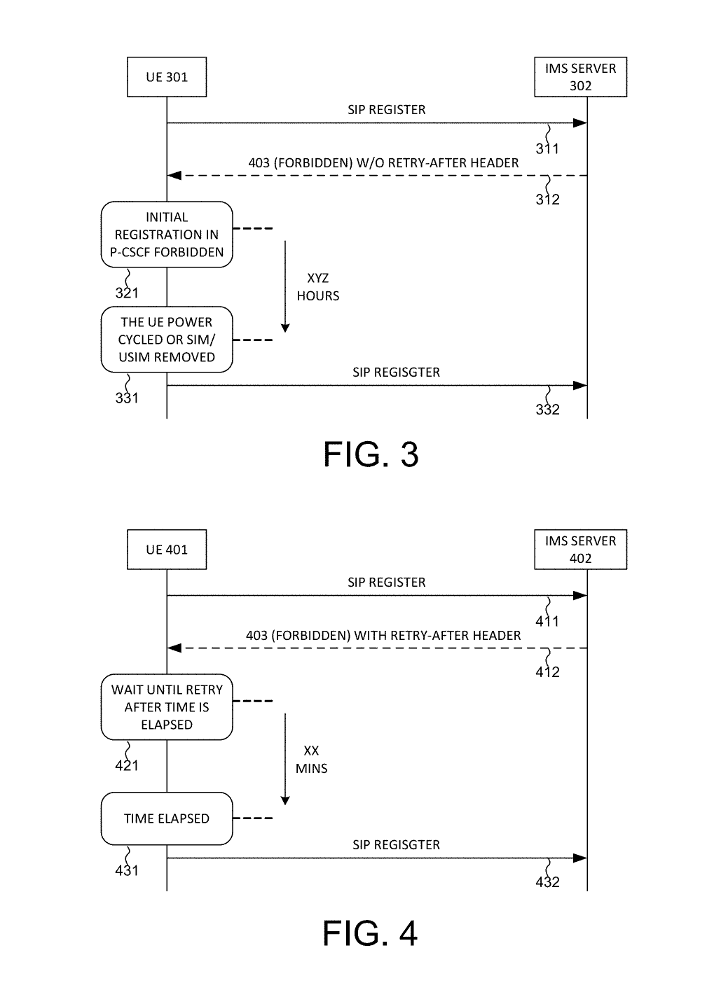

FIG. 3 illustrates a first embodiment of IMS registration after 403 without using new timer in accordance with one novel aspect. In step 311, UE 301 sends a SIP register to IMS server 302 for initial IMS registration. In step 312, IMS server 302 determines that the UE fails the IMS registration and sends 403 Forbidden response code back to UE 301. Under SIP, a Retry-After Header can be added in certain SIP message to specify a wait time for the next retry transmission. In the first embodiment, the Retry-After Header is not included in the 403 Forbidden response. As a result, UE 301 shall not retry the initial IMS registration in the IMS server (step 321). The UE shall wait until it is switched off and switched on again (power cycled) or the SIM/USIM card is removed (step 331). In step 332, UE 301 sends another SIP register to IMS server 302 for initial IMS registration.

FIG. 4 illustrates a second embodiment of IMS registration after 403 without using new timer in accordance with one novel aspect. In step 411, UE 401 sends a SIP register to IMS server 402 for initial IMS registration. In step 412, IMS server 402 determines that the UE fails the IMS registration and sends 403 Forbidden response code back to UE 401. Under SIP, a Retry-After Header can be added in certain SIP message to specify a wait time for the next retry transmission. In the second embodiment of FIG. 4, the Retry-After Header is included in the 403 Forbidden response. The operator can indicate the Retry-After time in the Retry-After header, which shall be elapsed before the UE can re-attempt the initial IMS registration in the IMS server again. As a result, in step 421, UE 401 waits until the Retry-After time is elapsed. In step 431, UE 401 determines that time has elapsed. In step 432, UE 401 sends another SIP register to IMS server 402 for initial IMS registration. Note that without using a new timer, the UE does not know when to retry the new IMS registration, which can be immediately (XX minutes) or after some time (XYZ hours).

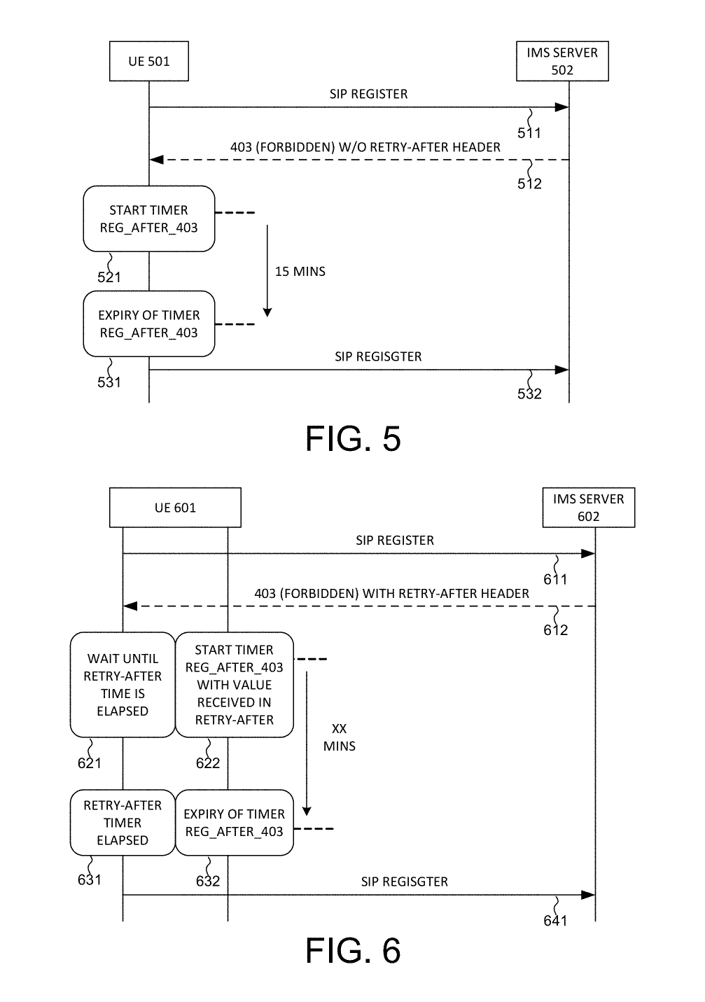

FIG. 5 illustrates a first embodiment of IMS registration after 403 using a new timer in accordance with one novel aspect. A new timer can be introduced for UE to control the reattempt of initial SIP registration, e.g., a reg_after_403 timer. If also used for other cause values, a more generic new timer, e.g., a reg_after_error timer can be introduced. The timer can be operator configurable. For example, the XML at SIP message header can be used to carry the timer value. The timer can be a predefined fixed value, e.g., 15 minutes. The timer can be P-CSCF specific, e.g., a separate timer instance per P-CSCF and/or IP-CAN. The timer can be common for initial SIP registration, e.g., not P-CSCF/IP-CAN specific.

In the first embodiment of FIG. 5, in step 511, UE 501 sends a SIP register to IMS server 502 for initial IMS registration. In step 512, IMS server 502 determines that the UE fails the IMS registration and sends 403 Forbidden response code back to UE 501. In this embodiment, the Retry-After Header is not included in the 403 Forbidden response. A new timer, e.g., reg_after_403, is configured for UE 501 to control the reattempt of initial SIP registration. As a result, in step 521, UE 501 starts the reg_after_403 timer upon receiving the 403 Forbidden response. In step 531, UE 501 detects the expiry of the reg_after_403 timer, e.g., after 15 minutes. In step 532, UE 501 sends another SIP register to IMS server 502 for initial IMS registration. Note that if Retry-After Header is not included in the 403 Forbidden response, then UE does not know when to retry the new IMS registration (immediately or after sometime). It is possible that the 403 Forbidden reason could be temporary internal failure. If the UE retry immediately, it may still result in IMS server failure and 403 Forbidden.

FIG. 6 illustrates a second embodiment of IMS registration after 403 using a new timer in accordance with one novel aspect. In step 611, UE 601 sends a SIP register to IMS server 602 for initial IMS registration. In step 612, IMS server 602 determines that UE 601 fails the IMS registration and sends 403 Forbidden response code back to UE 601. In this embodiment, the Retry-After Header is included in the 403 Forbidden response. In addition, a new timer, reg_after_403, is introduced for UE 601 to control the reattempt of initial SIP registration. UE 601 has two options to control the reattempt. In a first option, UE 601 does not start any timer. In step 621, UE 601 waits until the Retry-After time is elapsed. In step 631, UE 601 determines that time has elapsed. In a second option, in step 622, UE 601 starts the reg_after_403 timer upon receiving the 403 Forbidden response. Note that the timer is started with a value equal or longer than the time value in the Retry-After header. In step 632, UE 601 detects the expiry of the reg_after_403 timer, e.g., after XY minutes. In step 641, UE 601 sends another SIP register to IMS server 602 for initial IMS registration.

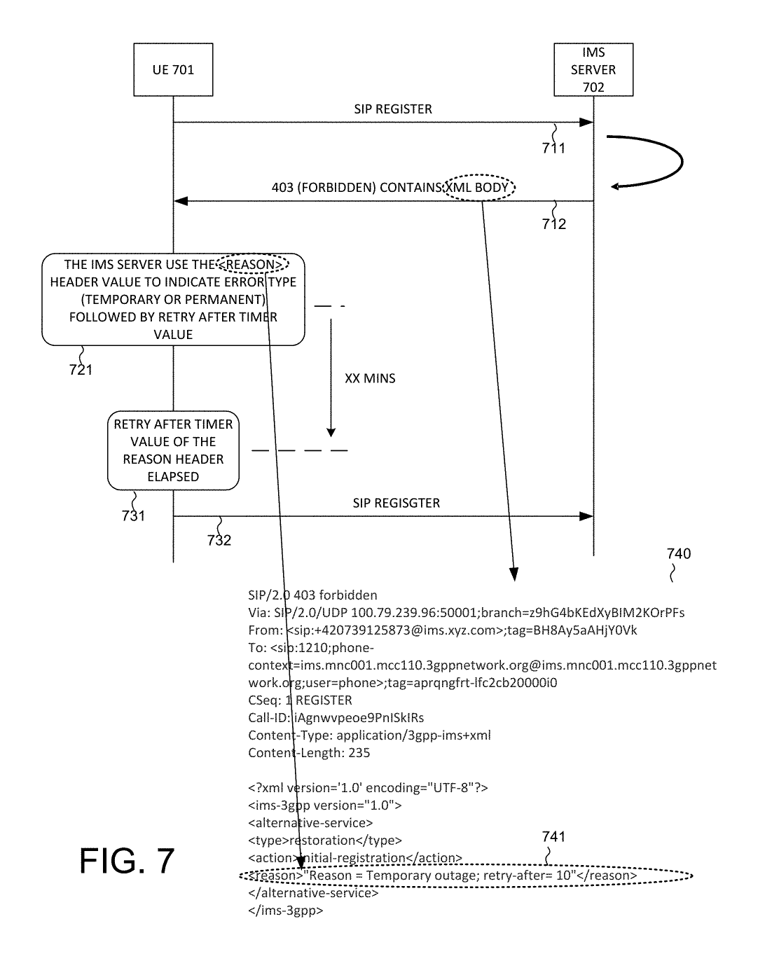

FIG. 7 illustrates one embodiment of IMS registration after 403 with reason header to carry error type indication followed by retry after timer value in accordance with one novel aspect. If the IMS server identifies that the failure reason for 403 is temporary internal failure and wants UE to retry after sometime, then the IMS server can add such information in the following XML in 403 response: 1) a Content-Type header field with the value set to associated MIME type of the 3GPP IM CN subsystem XML body; and 2) 3GPP IM CN subsystem XML body containing: an <ims-3gpp> element with the “version” attribute set to “1” and with an <alternative-service> child element, set to the parameters of the alternative service: i) a <type> child element, set to “restoration” (see table 7.6.2) to indicate that restoration procedures are supported; ii) a <reason> child element, set to an operator configurable reason to indicate if it is temporary or permanent failure reason followed by a retry after time interval; and iii) an <action> child element, set to “initial-registration”.

In the example of FIG. 7, In step 711, UE 701 sends a SIP register to IMS server 702 for initial IMS registration. In step 712, IMS server 702 determines that UE 701 fails the IMS registration and sends 403 Forbidden response code back to UE 701. In this embodiment, the 403 Forbidden response contains XML body (as depicted by 740), which further contains a <reason> child element (as depicted by 741). In step 721, UE 701 receives the <reason> header value provided by the IMS server 702. The <reason> header value is used to indicate 1) an error type: whether the reject reason is permanent or due to some temporary internal failure (e.g., timeout) and 2) a Retry-After timer value such that UE knows when to reattempt the next registration. Since the reason header is a string value, the format can be defined by the operator based on its network configuration and policy. In step 731, UE 701 waits until the Retry-After time is elapsed. In step 731, UE 701 determines that time has elapsed. In step 732, UE 701 sends another SIP register to IMS server 702 for initial IMS registration.

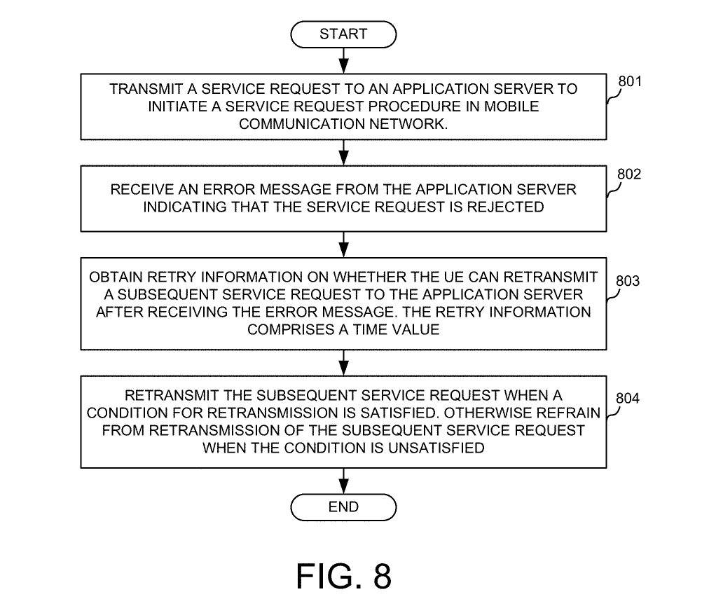

FIG. 8 is a flow chart of a method of supporting IMS registration after response code 403 in accordance with one novel aspect. In step 801, a UE transmits a service request to an application server to initiate a service request in a mobile communication network. In step 802, the UE receives an error message from the application server indicating that the service request is rejected. In step 803, the UE obtains retry information on whether the UE can re-transmit a subsequent service request to the application server after receiving the error message. The retry information comprises a time value. In step 804, the UE re-transmits the subsequent service request when a condition for retransmission is satisfied. Otherwise the UE refrains from retransmission of the subsequent service request when the condition is unsatisfied.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
transmitting a service request to an application server by a user equipment (UE) to initiate a service request in a mobile communication network;
receiving an error message from the application server indicating that the service request is rejected;
obtaining retry information on whether the UE can re-transmit a subsequent service request to the application server after receiving the error message, wherein the retry information comprises a time value; and
re-transmitting the subsequent service request when a condition for retransmission is satisfied, otherwise refrain from retransmission of the subsequent service request when the condition is unsatisfied.

2. The method of claim 1, wherein the service request is a session initiation protocol (SIP) Register, and wherein the application server is an IP Multimedia Subsystem (IMS) server.

3. The method of claim 2, wherein the error message comprises a SIP Error 403 forbidden response code.

4. The method of claim 2, wherein the error message comprises a Retry-After SIP Header containing the time value, and wherein the condition is satisfied when a duration of the time value has elapsed after receiving the error message.

5. The method of claim 2, wherein the time value is configured by the network, wherein the UE starts a timer with the time value upon receiving the error message, and wherein the condition is satisfied when the timer expires.

6. The method of claim 2, wherein the error message comprises a Retry-After SIP Header containing the time value, wherein the UE starts a timer with the time value upon receiving the error message, and wherein the condition is satisfied when the timer expires.

7. The method of claim 2, wherein the error message comprises the retry information including both an error type and the time value.

8. The method of claim 7, wherein the error type is either a temporary error or a permanent error.

9. The method of claim 7, wherein the condition is satisfied when the error type is a temporary error and a duration of the time value has elapsed after receiving the error message.

10. A User Equipment (UE), comprising:
a transmitter that transmits a service request to an application server by a user equipment (UE) to initiate a service request in a mobile communication network;
a receiver that receives an error message from the application server indicating that the service request is rejected by the application server;
a configuration circuit that obtains retry information on whether the UE can re-transmit a subsequent service request to the application server after receiving the error message, wherein the retry information comprises a time value; and
a service handling circuit that determines a condition for retransmission, wherein the UE re-transmits the subsequent service request when the condition is satisfied, otherwise the UE refrains from retransmission of the subsequent service request when the condition is unsatisfied.

11. The UE of claim 10, wherein the service request is a session initiation protocol (SIP) Register, and wherein the application server is an IP Multimedia Subsystem (IMS) server.

12. The UE of claim 11, wherein the error message comprises a SIP Error 403 forbidden response code.

13. The UE of claim 11, wherein the error message comprises a Retry-After SIP Header containing the time value, and wherein the condition is satisfied when a duration of the time value has elapsed after receiving the error message.

14. The UE of claim 11, wherein the time value is configured by the network, wherein the UE starts a timer with the time value upon receiving the error message, and wherein the condition is satisfied when the timer expires.

15. The UE of claim 11, wherein the error message comprises a Retry-After SIP Header containing the time value, wherein the UE starts a timer with the time value upon receiving the error message, and wherein the condition is satisfied when the timer expires.

16. The UE of claim 11, wherein the error message comprises the retry information including both an error type and the time value.

17. The UE of claim 16, wherein the error type is either a temporary error or a permanent error.

18. The UE of claim 16, wherein the condition is satisfied when the error type is a temporary error and a duration of the time value has elapsed after receiving the error message.
